(19) United States
(12) Patent Application Publication
(10) Pub. No.: US 2007/0171284 A1
(43) Pub. Date: Jul. 26, 2007

(54) Imager resolution enhancement based on mechanical pixel shifting

(75) Inventor: Joshua Posamentier, Oakland, CA (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/339,264

(22) Filed: Jan. 23, 2006

(51) Int. Cl. H04N 5/225

(52) U.S. Cl. 348/218.1

(57) ABSTRACT

Apparatus, systems and methods for imager resolution enhancement based on mechanical pixel shifting are disclosed. In one implementation, a system comprising a substrate, an imaging pixel array disposed on the substrate, imaging optics at least capable of providing an illumination field to the imaging pixel array, and one or more actuators disposed on the substrate and at least capable of moving the imaging pixel array relative to the illumination field is disclosed.

### BACKGROUND

Imagers, typically employing a monolithic integrated circuit (IC) imaging pixel array that converts light energy into electrical impulses, have seen dramatic increases in imaging resolutions recently. While innovations continue to provide for greater pixel array densities (i.e., smaller individual pixel “footprints”), fundamental design constraints are imposing limitations on how far this process can continue without unduly raising device costs or reducing sensor performance.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example imager system;

FIG. 2 illustrates an simplified schematic diagram of a small portion of an example imaging array;

FIG. 3 is a plan view illustrating portions of an imager housing assembly;

FIG. 4 is a side elevation view of portions of an imager housing assembly similar in structure to the imager housing assembly of FIG. 3;

FIG. 5 is a plan view illustrating portions of an imager housing assembly;

FIG. 6 is a side elevation view of portions of an imager housing assembly similar in structure to the imager housing assembly of FIG. 5;

FIG. 7 is a plan view illustrating portions of an imager housing assembly;

FIG. 8 is a side elevation view of portions of an imager housing assembly similar in structure to the imager housing assembly of FIG. 7;

FIG. 9 is a flow chart illustrating an example process for imager resolution enhancement based on mechanical pixel shifting; and

FIG. 10 a schematic representation of the relative position of an imaging array with respect to an optical illumination field.

### DETAILED DESCRIPTION

The following detailed description refers to the accompanying drawings. The same reference numbers may be used in different drawings to identify the same or similar elements. In the following description specific details may be set forth such as particular structures, architectures, interfaces, techniques, etc. in order to provide a thorough understanding of the various aspects of the claimed invention. However, such details are provided for purposes of explanation and should not be viewed as limiting with respect to the claimed invention. With benefit of the present disclosure it will be apparent to those skilled in the art that the various aspects of the invention claimed may be practiced in other examples that depart from these specific details. Moreover, in certain instances, descriptions of well known devices, circuits, and methods are omitted so as not to obscure the description of the present invention with unnecessary detail.

FIG. 1 illustrates an example imager system 100 in accordance with an implementation of the invention. System 100 includes an imager assembly 102, incorporating light gathering optics 104, and an image sensor array 106 mounted upon or held within an array housing assembly 108. System 100 also includes memory 110, a controller 112, one or more input/output (I/O) interfaces 114 (e.g., universal synchronous bus (USB) interfaces, parallel ports, serial ports, wireless communications ports, and/or other I/O interfaces), and a shared bus or other communications pathway 116 coupling devices 106 and 110-114 together for the exchange of, for example, image data and/or control data. System 100 may also include a an antenna 111 (e.g., dipole antenna, narrowband Meander Line Antenna (MLA), wideband MLA, inverted “F” antenna, planar inverted “F” antenna, Goubau antenna, Patch antenna, etc.) coupled to I/O interfaces 114.

System 100 may assume a variety of physical manifestations suitable for implementation of imager resolution enhancement based on mechanical solid state imager shifting in accordance with the invention. For example, imager system 100 may be implemented within a digital imaging device (e.g., digital camera, camcorder, cellular telephone handset, personal digital assistant (PDA) etc.). Moreover, various components of system 100 may be implemented in an integrated configuration rather than as discrete components. For example, memory 110, controller 112 and interfaces 114 may be implemented within one or more semiconductor device(s) and/or integrated circuit (IC) chip(s) (e.g., within a chipset, system-on-a-chip (SOC), etc.). Where system 100 is implemented in a mobile computing device (e.g., PDA) and/or mobile communications device (e.g., cellular telephone handset) antenna 111 may enable wireless communication between system 100 and external devices and/or communications networks. In addition, various components that might be associated with system 100 but that are not particularly relevant to the claimed invention (e.g., audio components, display-related logic, etc.) have been excluded from FIG. 1 so as to not obscure the invention.

Image sensor pixel array 106 may constitute a monolithic array of complementary metal oxide semiconductor (CMOS) diode elements or pixels formed in a silicon substrate although the invention is not limited in this regard and array 106 may include other types of semiconductor imaging elements, such as charge-coupled device (CCD) pixel elements. Although those skilled in the art will recognize that array 106 may include various elements such as a Bayer pattern color filter array overlaying the imaging pixels, control and/or processing logic circuits, electrical interconnects etc. that are not illustrated in FIG. 1, the specific nature of array 106 is not limiting with respect to the invention and hence will not be described in further detail.

Light gathering optics 104 may be any collection of light gathering optical elements capable and/or suitable for collecting light and providing that light to sensor 102. The light collected by optics 104 forms an illumination footprint in relation to array 106. Although those skilled in the art will recognize that optics 104 may comprise various optical components and/or arrangement of optical components, the specific nature of optics 104 is not limiting with respect to the invention and hence will not be described in further detail.

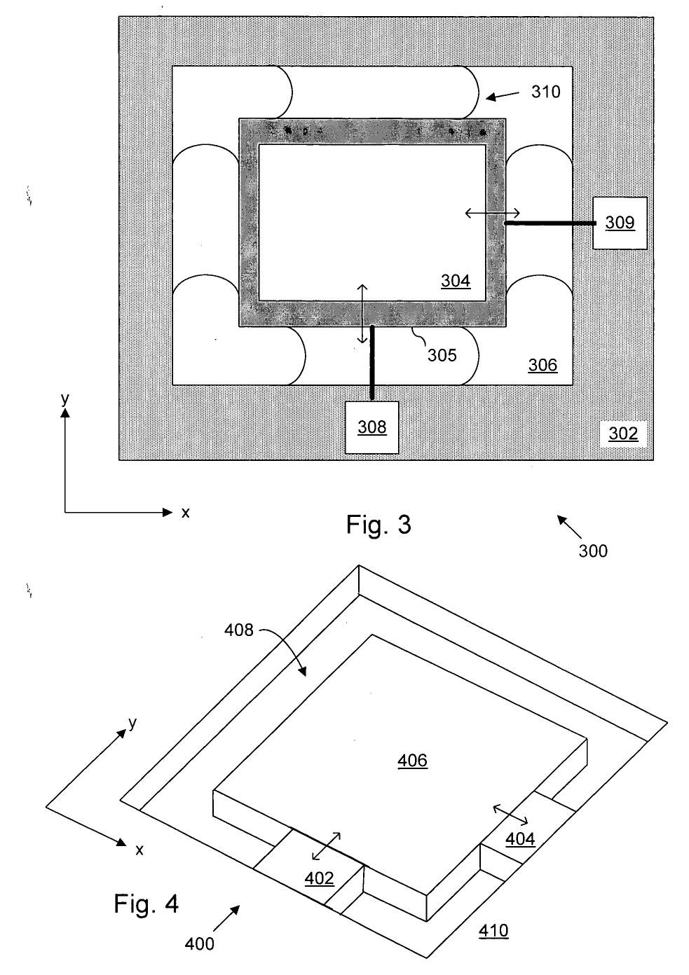

Housing assembly 108 may include any configuration of mechanical and/or electro-mechanical elements suitable for allowing the physical positioning of array 106 to be manipulated and/or moved and/or shifted within housing assembly 108 and/or with respect to the optical illumination footprint provided by optics 104, in accordance with the invention. Several example implementations of imager assemblies incorporating different housing assemblies in accordance with the invention will be described in more detail below with respect to FIGS. 3-8.

Memory 110 may be any device and/or mechanism capable of storing and/or holding imaging data including color pixel data and/or component values generated by sensor array 106, to name a few examples. For example, although the invention is not limited in this regard, memory 110 may be either volatile memory such as static random access memory (SRAM), dynamic random access memory (DRAM), or non-volatile memory such as flash memory. Memory 110 may store and/or hold calibration data and/or control data to be utilized by controller 112 to manipulate and/or move and/or shift the physical positioning of array 106 within housing assembly 108 and/or with respect to optics 104 and/or the optical illumination footprint provided by optics 104 as explained in greater detail below.

Controller 112 may be, in various implementations, any control and/or processing logic and/or collection of logic devices including control and/or processing logic capable of enabling the manipulation and/or moving and/or shifting of the physical orientation of array 106 within housing assembly 108 and/or with respect to optics 104 in accordance with the invention. For example, controller 112 may be capable of using positional encoders to determine the relative positioning of array 106 within housing assembly 108 and/or with respect to optics 104 and/or the optical illumination footprint provided by optics 104.

In various implementations controller 112 may be an image controller and/or signal processor. However, the invention is not limited in to a particular descriptive label for controller 112. For example, controller 112 may be implemented in a general purpose processor, microprocessor, and/or microcontroller to name a few other possibilities. Further, controller 112 may comprise a single device (e.g., a microprocessor, application specific IC (ASIC), etc.) or may comprise multiple devices and/or ICs. In one implementation, controller 112 may be capable of performing any of a number of tasks that support processes for imager resolution enhancement based on mechanical pixel shifting. These tasks may include, for example, although the invention is not limited in this regard, downloading microcode, initializing and/or configuring registers, and/or interrupt servicing.

As noted above, controller 112 may include both control logic and processing logic. As will be explained in further detail below the control logic may be capable of providing control signals to physical manipulate array 106, while the processing logic may be capable of sensing resulting motion of array 106 and timing the optical exposure of array 106 to those times when array 106 is stationary or nearly stationary. Moreover, the processing logic may also be capable of determining the relative positioning of array 106 within housing assembly 108 and/or with respect to optics 104 and/or the optical illumination footprint provided by optics 104. In another implementation, controller 112 may include processing logic while array 106 may include control logic. In a further implementation, array 106 may incorporate both processing logic and/or control logic in whole or in part. Clearly the invention is not limited by which device incorporates the control and/or processing logic that may be associated with system 100.

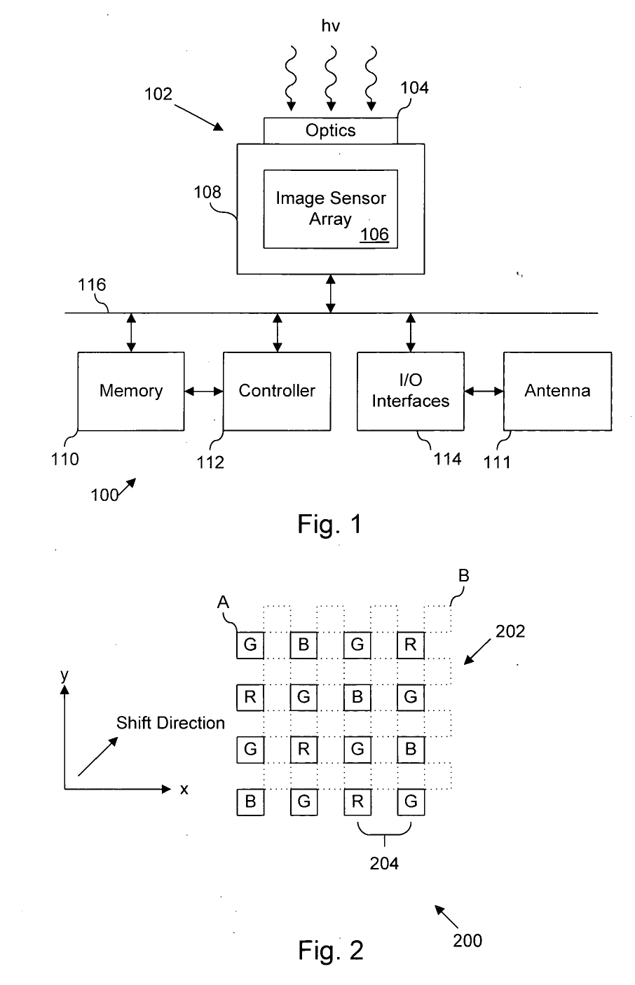

FIG. 2 is a simplified schematic diagram illustrating a small portion 200 of an imaging array, such as array 106, comprising a 4-by-4 block of imaging pixels 202. As one skilled in the art will recognize, portion 200 shows pixels 202 arranged in a pattern wherein each pixel 202 collects light of primarily one color (i.e., green (G), red (R), or blue (B)) as a result of a color filter array (CFA), for example, a Bayer pattern CFA (not shown) positioned between portion 200 and the light gathering optics (e.g., optics 104). The invention is not limited in this regard, however, and pixels 202 may comprise any imaging pixel type (i.e., CMOS or CCD; color and/or monochromatic) arranged with respect to a CFA such that the array's pixel sample colors in any pattern, Bayer or otherwise. Moreover, the invention is not limited with respect to the shape of the pixel array whether it is rectangular, hexagonal, or some other geometric arrangement.

In accordance with the invention, control logic (e.g., within controller 112) may utilize a device or devices to manipulate the array that includes portion 200 so that pixels 202 are moved and/or shifted relative to the light or optical illumination footprint or field provided to those pixels by the light gathering optics (e.g., optics 104). In this way, as the array is shifted from position A to position B (represented by the dashed pixels in FIG. 2) pixels 202 may be exposed to different portions of the optical illumination field supplied by the light gathering optics. FIG. 2 shows an example shift magnitude of approximately one-half the pixel pitch 204 of the array with a two-dimensional shift direction of approximately 45° with respect to an arbitrary x-y orientation origin. Pixel pitch 204 may range in value from 10-25 microns (μm) although the invention is not limited in this regard. Moreover, the shift shown in FIG. 2 is just an example shift and, as will be explained in greater detail below, the invention is not limited to a particular shift magnitude and/or shift orientation. For example, shifts comprising any fraction an array's pixel pitch (such as ¼ of the pixel pitch or more) may be undertaken in accordance with the invention. Moreover, as will also be explained in greater detail below, the motion undertaken by the array may comprise a series of discrete positional shifts undertaken at high frequency (e.g., 10 kHz) where each discrete shift may be only a small fraction of the pixel pitch.

FIG. 3 is a plan view illustrating portions of an imager housing assembly 300, such as may comprise housing assembly 108 of FIG. 1, in accordance with an implementation of the invention. Assembly 300 includes a substrate 302, an imaging array 304 housed and/or held within a recess 306 of substrate 302. Those skilled in the art will recognize that array 304 may be a monolithic imaging array formed within a substrate such as a silicon substrate or “chip” as a single IC. Thus, when, in this disclosure, an imaging array, such as array 304, is referred to simply as an “array” it will be understood that the term “array” implies additional elements such as the interconnects between the array and external devices or ancillary circuitry required for the imaging elements to operate, etc. that have been excluded from the illustration of, for example, array 304 of FIG. 3, so as to not needlessly complicate the description provided herein.

Assembly 300 also includes at least two linear mechanical actuators 308 and 309 disposed in a substantially orthogonal relationship to each other and suitable for manipulating and/or moving and/or shifting the physical position of array 304 in a substantially two-dimensional fashion within recess 306 and thereby with respect to substrate 302. Assembly 300 may also include a set of compliant elements 310 suitable for maintaining the position of array 304 within recess 306 after array 304 is physically manipulated by actuators 308 and 309.

In one implementation, actuator 308 may move array 304 in the “y” direction of the arbitrary x-y coordinate system shown in FIG. 3, while actuator 309 may move array 304 in the “x” direction. Thus, acting together, actuators 308 and 309 may freely manipulate the position of array 304 in the x-y plane consistent with the motional limits imposed by recess 306, compliant elements 310 and the inherent motional limitations of actuators 308 and 309 themselves. Those skilled in the art will recognize that assembly 300 may be incorporated into a leadframe package such as ceramic leadless chip carrier (CLCC) although the invention is not limited in this regard. Further, those skilled in the art will recognize that array 304 may be formed within and/or upon a semiconductor die 305 that may be the physical object that actuators 308 and 309 actually manipulate when moving and/or shifting the physical position of array 304.

In accordance with the invention, control logic (e.g., within controller 112 of FIG. 1) may utilize either one or both of actuators 308 and 309 to position array 304 within recess 306. Thus, for example, control logic could control both actuators 308 and 309 to move array 304 in a two-dimensional manner within recess 306. In another implementation, control logic could control both actuators 308 and 309 to move array 304 in an overall sinusoidal manner within recess 306. In one implementation, actuators 308 and 309 may comprise stacks of piezoelectric crystals driven electronically by control logic incorporating digital-to-analog converter (DAC) or pulse width modulation (PWM) circuitry and a current driver. The invention is not, however, limited to a particular type of linear actuator. Moreover, the use of piezoelectric crystals and associated drive circuitry for the purposes of linear actuation is well recognized by those skilled in the art and thus these components will not be described in greater detail herein.

FIG. 4 is a side elevation view of portions of portions of an imager housing assembly 400, similar in structure to assembly 300, but employing piezoelectric actuator stacks 402 and 404 to move an array 406 within a recess 408 of a substrate 410. In accordance with the invention, control logic may utilize one and/or both of actuators 402 and/or 404 to position array 406 within recess 408 consistent with the motion limits introduced by recess 408, substrate 410, compliant elements (not shown), and the motional limitations of actuators 402 and 404. Those skilled in the art will recognize that some elements, such as compliant leadframe elements, interconnect structures for array 406, etc. have been excluded from FIG. 4 in the interests of clarity. Various schemes for using assemblies such as assembly 300 or assembly 400 in accordance with the invention will be discussed in greater detail below.

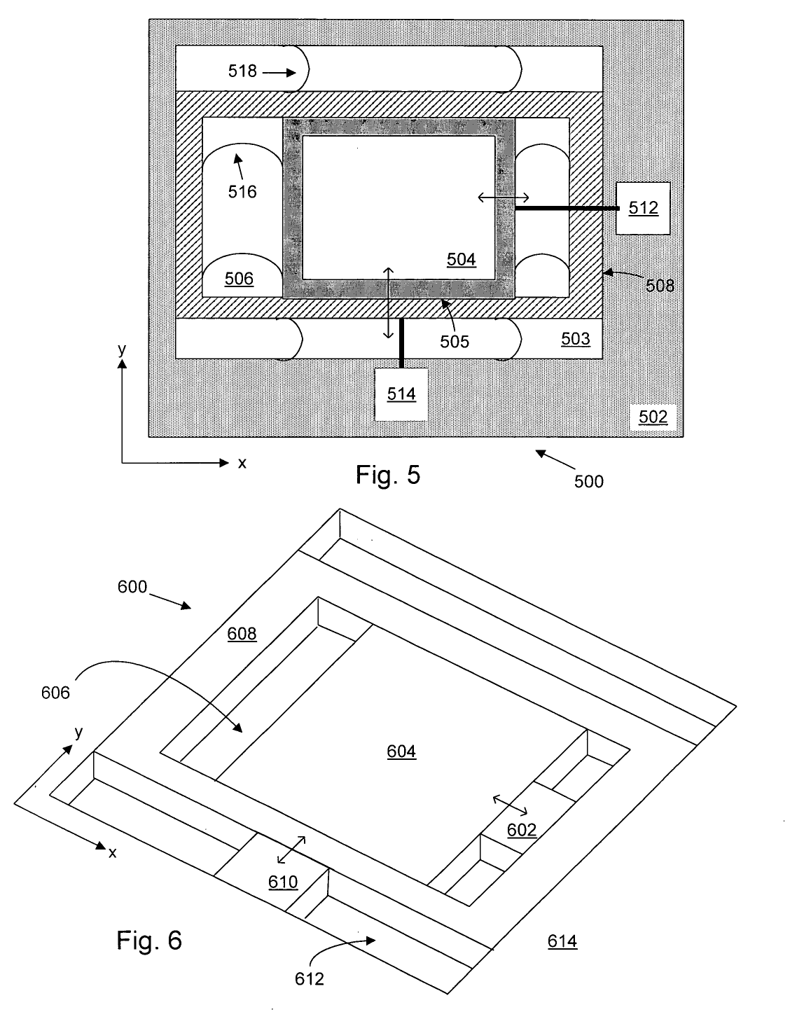

FIG. 5 is a plan view illustrating portions of an imager housing assembly 500, such as may comprise housing assembly 108 of FIG. 1, in accordance with another implementation of the invention. Assembly 500 includes a first substrate 502 having a recess 503 and an imaging array 504 held within a recess 506 of a second substrate 508. Substrate 508 is, in turn, housed and/or held within recess 503 of substrate 502. Assembly 500 also includes at least a first linear mechanical actuator 512 disposed in a substantially orthogonal relationship to a second linear mechanical actuator 514. Furthermore, assembly 500 may include a first set of compliant elements 516 suitable for maintaining the position of array 504 within recess 506 as assembly 505 is physically manipulated by actuator 512, and a second set of compliant elements 518 suitable for maintaining the position of substrate 508 within recess 503 as substrate 508 is physically manipulated by actuator 514. Those skilled in the art will recognize that assembly 500 may be incorporated into a leadframe package such as a CLCC package although the invention is not limited in this regard. Further, those skilled in the art will recognize that array 504 may be formed within and/or upon a semiconductor die 505 that may be the physical object that actuator 512 actually manipulates when moving and/or shifting the physical position of array 504.

Within assembly 500 the first actuator 512 may manipulate and/or move and/or shift the physical position of array 504 in a first direction (e.g. the “x” direction of the arbitrary x-y coordinate system shown in FIG. 5) within recess 506 and thereby with respect to substrate 508, while the second actuator 514 may manipulate and/or move and/or shift the physical position of substrate 508 in a second direction (e.g., the “y” direction) within recess 503 and thereby with respect to substrate 502, where the first and second directions are substantially orthogonal to each other. In this manner, in accordance with the invention, actuators 512 and 514 may act together to manipulate and/or move and/or shift array 504 in a two-dimensional manner with respect to substrate 502. In one implementation, actuators 512 and 514 may comprise stacks of piezoelectric crystals driven electronically by control logic (e.g., controller 112) incorporating DAC or PWM circuitry and a current driver.

FIG. 6 is a side elevation view of portions of portions of an imager housing assembly 600, similar in structure to assembly 500, but employing a first piezoelectric actuator 602 to move an array 604 in a first direction within a recess 606 of a first substrate 608, and a second piezoelectric actuator 610 to move substrate 608 in a second direction within a recess 612 of a second substrate 614. Those skilled in the art will recognize that some elements, such as compliant leadframe elements, have been excluded from FIG. 6 in the interests of clarity.

In accordance with the invention, control logic (e.g., within controller 112 of FIG. 1) may utilize one and/or both of actuators 512 and/or 514 to position array 504 within recess 503 consistent with the motion limits introduced by recesses 506 and 503, substrates 502 and 508, compliant elements 516 and 518, and the motional limitations of actuators 512 and 514. Thus, for example, control logic could control both actuators 512 and 514 to move array 504 in an overall sinusoidal manner within recess 503. Similarly, control logic may utilize one and/or both of actuators 602 and/or 610 to position array 604 within recess 612 consistent with the motion limits introduced by recesses 606 and 612, substrates 608 and 614, compliant elements (not shown), and the motional limitations of actuators 602 and 610. Various schemes for using assemblies such as assembly 500 or assembly 600 in accordance with the invention will be discussed in greater detail below.

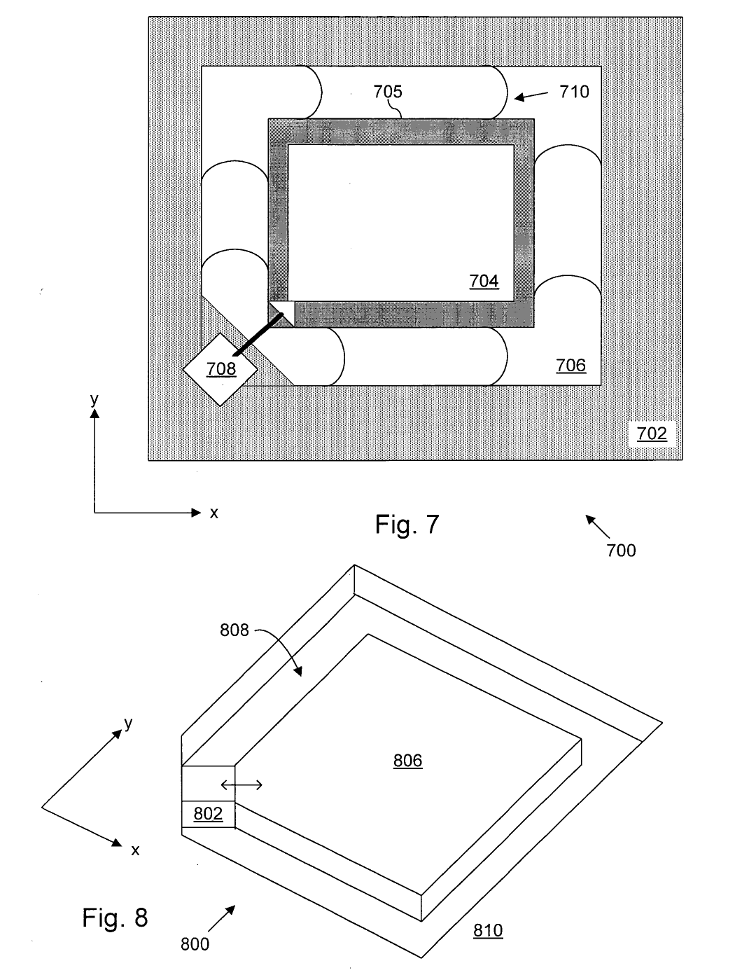

FIG. 7 is a plan view illustrating portions of an imager housing assembly 700, such as may comprise housing assembly 108 of FIG. 1, in accordance with another implementation of the invention. Assembly 700 includes a substrate 702 having a recess 706 and an imaging array 704 housed and/or held within recess 706. Assembly 700 also includes a linear mechanical actuator 708 disposed in a substantially 45° orientation with respect to substrate 702 and array 704. Furthermore, assembly 700 may include a set of compliant elements 710 suitable for maintaining the position of array 704 within recess 706 as array 704 is physically manipulated by actuator 708. Those skilled in the art will recognize that assembly 700 may be incorporated into a leadframe package such as a CLCC package although the invention is not limited in this regard. Further, those skilled in the art will recognize that array 704 may be formed within and/or upon a semiconductor die 705 that may be the physical object that actuator 708 actually manipulates when moving and/or shifting the physical position of array 704.

Within assembly 700 actuator 708 may manipulate and/or move and/or shift the physical position of array 704 in a diagonal direction (e.g. at 45° with respect to the “x” and “y” directions of the arbitrary x-y coordinate system shown in FIG. 7) within recess 706 and thereby with respect to substrate 702. In this manner, in accordance with the invention, actuator 708 may act to manipulate and/or move and/or shift array 704 in a one-dimensional manner with respect to substrate 502. In one implementation, actuator 708 may comprise a stack of piezoelectric crystals driven electronically by control logic (e.g., controller 112) incorporating DAC or PWM circuitry and a current driver.

FIG. 8 is a side elevation view of portions of portions of an imager housing assembly 800, similar in structure to assembly 700, but employing a piezoelectric actuator 802 to move an array 806 diagonally within a recess 808 of a substrate 810. Those skilled in the art will recognize that some elements, such as compliant leadframe elements, have been excluded from FIG. 8 in the interests of clarity. Various schemes for using assemblies such as assembly 700 or assembly 800 in accordance with the invention will be discussed in greater detail below

In accordance with the invention, control logic (e.g., within controller 112 of FIG. 1) may utilize actuator 708 to position array 704 within recess 706 consistent with the motion limits introduced by recess 706, substrate 702, compliant elements 710, and the motional limits of actuator 708 itself. Similarly, control logic may utilize actuator 802 to position array 806 within recess 808 consistent with the motion limits introduced by recess 808, substrate 810, the compliant elements (not shown), and the motional limits of actuator 802 itself. Various schemes for using assemblies such as assembly 700 or assembly 800 in accordance with the invention will be discussed in greater detail below.

In accordance with an implementation of the invention, control and/or processing logic included within associated with and/or distributed amongst the controller (e.g., controller 112), the imaging array (e.g., arrays 304, 406, 504, 604, 704 and/or 806) and/or the actuators (e.g., actuators 308/309, 402/404, 512/514, 602/610 and/or 708/802) may incorporate positional encoders (not shown) capable of providing information on the position of the array when acted upon by the actuators. The use of positional encoders to aid in the control of linear actuators is well known in the art and thus will not be described in greater detail herein. In accordance with implementations of the invention, control and/or processing logic in, for example, controller 112 may use the positional information supplied by the positional encoders to accurately control the moving, shifting and/or manipulation of the position of the imaging array.

In accordance with an implementation of the invention, the control and/or processing logic may use a predetermined data table to accurately control the moving, shifting and/or manipulation of the position of the imaging array. Thus, for example, controller 112 of system 100 may have access to one or more lookup tables (LUTs) stored in internal controller memory (not shown) or in other memory (e.g., memory 110) where those LUTs may correlate, for example, the displacement of the actuators as a function of the current used to drive the actuators. Thus, the controller may use the LUT(s) to determine the proper current to supply the actuators in order to move the array to a particular location.

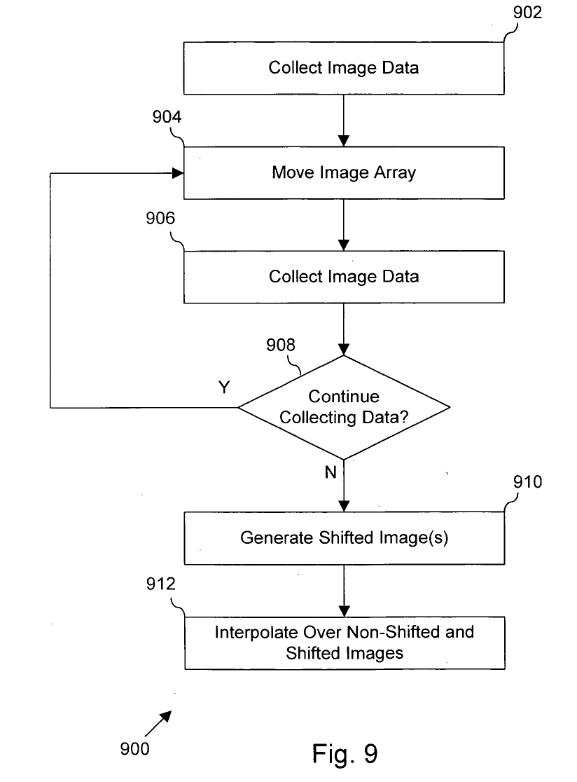

FIG. 9 is a flow diagram illustrating a process 900 for imager resolution enhancement based on mechanical pixel shifting in accordance with implementations of the claimed invention. While, for ease of explanation, process 900, and associated processes, may be described with regard to system 100 of FIG. 1, array portion 200 of FIG. 2, and/or the assemblies shown FIGS. 3-8, the claimed invention is not limited in this regard and other processes or schemes supported and/or performed by appropriate devices and/or combinations of devices in accordance with the claimed invention are possible.

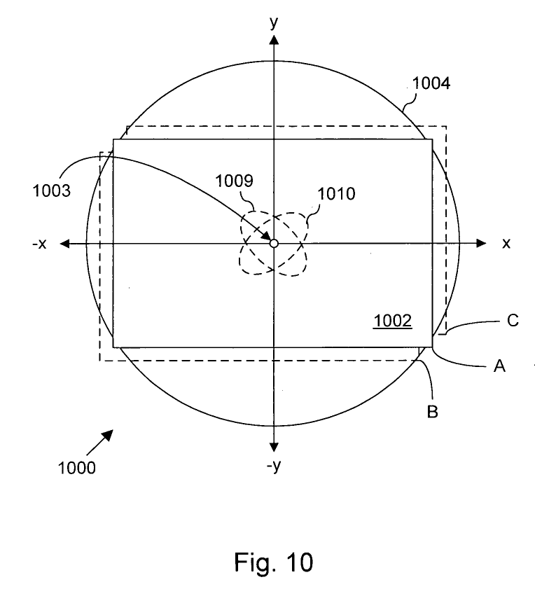

FIG. 10 illustrates a schematic representation 1000 of the relative position of an array 1002, such as arrays 106, 304, 406, 504, 604, 704, and/or 806, with respect to an optical illumination field or footprint 1004, such as might be provided by optics 104. In accordance with the invention, and as will be further explained with respect to process 900, the motion of a center point 1003 of array 1002, chosen to lie at the origin of an arbitrary x-y coordinate system when array 1002 is at rest (position “A”), may execute a variety of trajectories, such as example trajectories 1009 and 1010, when acted upon by linear actuators (e.g., actuators 308/309, 402/404, 512/514, 602/610 and/or 708/802). In addition, shifted array positions labeled “B” and “C” are intended to represent two example positions of array 1002 along another example shift trajectory as will be further explained with respect to process 900. Overall, FIG. 10 is offered to help explain portions of process 900 and is not intended to be a dimensionally accurate representation. For example, while array 1002 may, itself be on the order of centimeters in extent, the example trajectories 1009 and 1010, and/or the shift distance between positions B and C may span only about 20-30 microns (μm) in extent.

Process 900 may begin with the collection of image data [act 902]. In one implementation, controller 112 may supply control data to shutter devices (not shown) within array 106 instructing the shutter devices to expose the corresponding hold device (not shown) of each pixel of array 106 to light provided by optics 104. Alternatively, controller 112 may supply control data to a single global shutter device (not shown) disposed between optics 104 and array 106 opening the shutter and thereby exposing the pixels of array 106 to light provided by optics 104. In one implementation, act 902 may be undertaken when the array is in a non-shifted position. For example, referring to FIG. 10, act 902 may be undertaken when array 1002 is in the position labeled “A.”

Act 902 may include accessing the imaging array to obtain the image data and digitizing that data using known techniques. In one implementation, processing logic incorporated into array 106 (or 304, 406, 504, 604, 704, and/or 806) may employ, among other components, analog-to-digital conversion (ADC) circuitry to convert collected analog image data into digital image data. As part of the data collection of act 902, the digitized image data may be placed and/or stored in memory 110 as a non-shifted image.

Process 900 may continue with moving the image array [act 904]. One way to do this, referring to the example implementation of FIGS. 1, 3, and 4, is to have control logic shift the position of array 304/406 relative to substrate 302/410 by supplying control signals to actuators 308/309 and/or 402/404. For example, control logic in controller 112 may access a LUT stored internally in controller 112 or in memory 110 to determine how to manipulate actuators 308/309 and/or 402/404 in order to move array 304/406 to a particular position. That LUT may provide the control logic with a specific current value required for a drive signal (i.e., control signal) supplied to actuators 308/309 and/or 402/404 to move array 304/406 to a certain position in recess 306/408.

Another way to implement act 904, referring to the example implementations of FIGS. 1, 5 and 6, is to have control logic shift the position of array 504/604 relative to substrate 502/604 by supplying control signals to actuators 512/514 and/or 602/610. For example, control logic in controller 112 may access a LUT stored internally in controller 112 or in memory 110 to determine how to manipulate actuators 512/514 and/or 602/610 in order to move array 504/604 to a particular position. That LUT may provide the control logic with a specific current value required for a drive signal (i.e., control signal) supplied to actuators 512/514 and/or 602/610 to move array 504/604 to a certain position in recess 503/612.

Yet another way to implement act 904, referring to the example implementations of FIGS. 1, 7 and 8, is to have control logic shift the position of array 704/806 relative to substrate 702/810 by supplying control signals to actuators 708/802. For example, control logic in controller 112 may access a LUT stored internally in controller 112 or in memory 110 to determine how to manipulate actuators 708/802 in order to move array 704/806 to a particular position. That LUT may provide the control logic with a specific current value required for a drive signal (i.e., control signal) supplied to actuators 708/802 to move array 504/604 to a certain diagonal position in recess 706/808.

In one implementation, referring to FIGS. 1, and 3-8, the LUT stored internally in controller 112 or in memory 110 may be generated beforehand based on observed motion of the array as a function of current supplied to the actuator(s). Similarly, the LUT may provide the control logic with a specific current value required for a drive signal (i.e., control signal) supplied to the actuator(s) to move the array to a certain position. Alternatively, another way to implement act 904 is to have the control and/or processing logic include positional encoders (not shown) so that by monitoring the positional encoders the control and/or processing logic may undertake 904.

While, in accordance with the invention, act 904 may be undertaken to move the array to an arbitrary position, FIG. 10 provides some examples for the purposes of discussion. Thus, while act 902 may be undertaken with array 1002 in the x-y position labeled “A” in FIG. 10, act 904 may comprise moving array 1002, using the linear actuators, from the “A” position to the position labeled “B” in FIG. 10.

Process 900 may continue with collection of image data [act 906] with the array in the position attained in act 904. The collection of image data in act 906 may be undertaken in a manner similar to that described in act 902 above. Thus, act 906 may include accessing the image data and digitizing that data using known techniques. In one implementation, processing logic incorporated into array 304 (or 406, 504, 604, 704, or 806) may employ, among other components, analog-to-digital conversion (ADC) circuitry to convert collected analog image data into digital image data. As part of the data collection of act 906, the digitized image data may be placed and/or stored in memory 110 as a first shifted image.

Process 900 may continue with a determination of whether to continue with collecting image data [act 908]. In one implementation, controller 112 may undertake the decision of act 908 based upon a specific set of instructions provided to controller 112. For example, if process 900 is to provide for a array motion trajectory like that of trajectories 1009 or 1010, then acts 904-906 may represent one iteration of a sequence of events designed to move array 1002 along a trajectory such as 1009 or 1010 and hence controller 112 may undertake one or more additional iterations of acts 904-906 to achieve motion along one of these trajectories.

If the result of act 908 is negative, that is, if controller 112 determines that further image data is not to be collected then process 900 may continue with the generation of shifted image(s) [act 910]. For example, in one implementation, controller 112 may have undertaken acts 904-906 a number of times so as to have array 1002 follow, for example, trajectory 1009. Trajectory 1009 might, in turn, for example, comprise a sequence of iterations of acts 904-906 so that array 1002 is moved through a specific set of positions (x,y) and digitized image data is obtained at each position. Thus, if acts 904-906 are repeated such that array 1002 executes motion along trajectory 1009 a specific number of times then a corresponding number of digitized image data sets may be obtained for each position (x,y). Act 910 may then comprise averaging those digitized image data sets that are obtained for each position (x,y) to generate a single shifted image for each position (x,y).

In another example implementation, controller 112 may have undertaken acts 904-906 twice so as to place array 1002 in positions “B” and “C” where digitized image data is obtained at each position. Thus, acts 904-906 may be repeated so that array 1002 moves to position “B” where an image data set is collected and then to position “C” where another image data set is collected. Act 910 may then comprise averaging those digitized image data sets for positions “B” and “C” to generate a single shifted image.

Process 900 may continue with interpolation over shifted and non-shifted images [act 912]. In one implementation, processing logic in controller 112 may access memory 112 to obtain the non-shifted image generated in act 902 and the shifted images generated each iteration of act 906 and may then interpolate between those shifted and non-shifted images to obtain a final image product. While simple averaging may be employed in the interpolation of act 912, the invention is not limited in this regard and any suitable interpolation scheme may be employed in act 912.

The acts shown in FIG. 9 need not be implemented in the order shown; nor do all of the acts necessarily need to be performed. For example, the interpolation of act 912 may take place off-device at a later time. Also, those acts that are not dependent on other acts may be performed in parallel with the other acts. For example, multiple iterations of acts 904-906 may occur so that the generation of shifted image(s) in act 910 associated with one iteration of acts 904-906 may occur in parallel with a subsequent iteration of acts 904-906. Moreover, some acts of processes 900 may be implemented in and/or undertaken using hardware and/or firmware and/or software. For example, the acts in process 900 of deciding whether to continue collecting data (act 908) and interpolating over non-shifted and shifted images (act 912) may be implemented using software, while other acts such as collecting image data (acts 902 and 906) may be implemented in hardware and/or firmware. However, the invention is not limited in this regard and acts that may be implemented in hardware and/or firmware may, alternatively, be implemented in software. Clearly, many such combinations of software and/or hardware and/or firmware implementation of process 900 may be contemplated consistent with the scope and spirit of the invention. Further, at least some of the acts in process 900 may be implemented as instructions, or groups of instructions, implemented in a machine-readable medium.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. Clearly, many implementations may be employed to provide a method, apparatus and/or system to implement image sensor leakage and dark current compensation consistent with the claimed invention.

No element, act, or instruction used in the description of the present application should be construed as critical or essential to the invention unless explicitly described as such. Also, as used herein, the article “a” is intended to include one or more items. In addition, some terms used to describe implementations of the invention, such as “pixel data” and “image data,” may be used interchangeably in some circumstances. For example, those skilled in the art will recognize that the terms “pixel value” and “pixel data” may be used interchangeably without departing from the scope and spirit of the invention. Moreover, when terms such as “coupled” or “responsive” are used herein or in the claims that follow, these terms are meant to be interpreted broadly. For example, the phrase “coupled to” may refer to being communicatively, electrically and/or operatively coupled as appropriate for the context in which the phrase is used. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method comprising:
collecting first image data from an imaging array held in a first position relative to an illumination field;
moving the imaging array from the first position to a second position relative to the illumination field; and
collecting second image data.

2. The method of claim 1, further comprising:
interpolating between the first and second image data to obtain interpolated image data.

3. The method of claim 2 wherein interpolating comprises averaging the first and second image data.

4. The method of claim 1, wherein the first position and the second position are separated by a distance equal to at least one quarter of a pixel pitch of the imaging array.

5. The method of claim 1, wherein moving the imaging array from the first position to the second position comprises mechanically shifting the imaging array using at least one linear actuator.

6. The method of claim 1, further comprising:
moving the imaging array from the second position to a third position relative to the illumination field; and
collecting third image data.

7. The method of claim 6, further comprising:
interpolating amongst the first, second and third image data to obtain interpolated image data.

8. The method of claim 1, wherein moving the imaging array from the first position to the second position comprises:
using one or more linear actuators to move the imaging array from the first position to the second position.

9. The method of claim 8, wherein using on or more linear actuators to move the imaging array from the first position to the second position further comprises:
using one or more positional encoders coupled to the one or more linear actuators to control moving the imaging array from the first position to the second position.

10. An apparatus comprising:
an image sensor pixel array disposed upon a substrate; and
one or more actuators at least capable of moving the pixel array relative to the substrate.

11. The apparatus of claim 10, further comprising:
control logic at least capable of controlling the one or more actuators.

12. The apparatus of claim 11, further comprising:
positional encoders coupled to the one or more actuators; and
processing logic at least capable of using the positional encoders to determine positioning of the pixel array relative to the substrate.

13. The apparatus of claim 12, wherein the control logic is at least capable of using the positional encoders and the one or more actuators to move the pixel array from a first position relative to the substrate to a second position relative to the substrate.

14. The apparatus of claim 13, wherein the first position and the second position are separated by a distance equal to at least one quarter of a pixel pitch of the pixel array.

15. A system comprising:
a substrate;
an imaging pixel array disposed on the substrate;
imaging optics at least capable of providing an illumination field to the imaging pixel array; and
one or more actuators disposed on the substrate and at least capable of moving the imaging pixel array relative to the illumination field.

16. The system of claim 15, further comprising:
control logic at least capable of controlling the one or more actuators.

17. The system of claim 16, further comprising:
positional encoders coupled to the one or more actuators; and
processing logic at least capable of using the positional encoders to determine positioning of the imaging pixel array relative to the substrate.

18. The system of claim 17, wherein the control logic is at least capable of using the positional encoders and the one or more actuators to move the imaging pixel array from a first position relative to the substrate to a second position relative to the substrate.

19. The apparatus of claim 18, wherein the first position and the second position are separated by a distance equal to at least one quarter of a pixel pitch of the imaging pixel array.

20. The system of claim 15, further comprising:
a controller coupled to the imaging pixel array.
